(19) United States
(12) Patent Application Publication
(10) Pub. No.: US 2002/0135460 A1
(43) Pub. Date: Sep. 26, 2002

(54) Access authorization entry method

(76) Inventor: Rudolf Stockhammer, St. Gilgen (AT)

Correspondence Address: David S Goldenberg, Flynn Thiel Boutell & Tanis, 2026 Rambling Road, Kalamazoo, MI, 49008-1699, US

(21) Appl. No.: 09/980,374

(22) PCT Filed: Feb. 22, 2001
(86) PCT No.: PCT/EP01/02029

(30) Foreign Application Priority Data
Mar. 29, 2000 (DE) 100 15 732.7

(51) Int. Cl. G06F 17/60; H04Q 1/00

(52) U.S. Cl. 340/5.61; 705/5

(57) ABSTRACT

For booking access entitlement to a facility accessible with a data carrier (5) via an access terminal (8) provided with a data communication device (9) for reading and for reading and coding data on the data carrier (5), the data carrier (5) is coded with identification data. The identification data are at the same time provided visibly (6) on the data carrier (5). The identification data are conveyed together with the access entitlement data to be booked via a telecommunication device to the access terminal (8) and stored there. The data carrier (5) is identified at the access terminal (8) by comparison of the identification data coded thereon with the stored identification data, whereupon the booked access entitlement data are coded on the identified data carrier (5) by the data communication device (9).

This invention relates to a method for booking access entitlement to a facility accessible with a codable data carrier via an access terminal provided with a data communication device for reading and for reading and coding data on the data carrier.

Such access terminals are provided in particular at the lifts of winter sports facilities. The data carriers used are in particular contactlessly communicating data carriers, in particular RFID (radio frequency identification) transponders, which are also supplied with energy for data communication at the access terminal. The contactlessly communicating data carrier can e.g. be integrated into a watch or a card which can be fastened to a garment.

Upon purchase of access entitlement the purchased access entitlement, e.g. a day ski pass for an adult, is coded on the data carrier. The purchase, which takes place at a ticket office of the winter sports facility, thus takes a certain time. The ticket office of a winter sports facility often undergoes such an onrush especially in the morning, however, that long waits at the ticket office are among the agonizing experiences of many winter sports enthusiasts.

The problem of the invention is to provide a booking method which substantially relieves the ticket offices or other facilities where the purchased access entitlement is coded on the data carrier.

This is obtained according to the invention with the method characterized in claim 1. The subclaims render advantageous embodiments of the invention.

The data carrier used is in particular an electronic data carrier. Both contact-type and contactless-type electronic data carriers such as RFID transponders have a microchip. Each microchip has a unique identifier (chip serial number or other number or code) with which it is coded. This identifier stored in the chip forms the starting point of the invention. If the chip serial number or other identifier of the chip is also provided visibly on the data carrier, the inventive booking method can be performed.

The sports enthusiast or general customer dials the phone number intended for booking access entitlements in the relevant winter sports area or facility e.g. with a mobile phone for example on the way to the winter sports area or facility. He then conveys to this phone number, preferably by SMS, the identification data provided visibly on his individual data carrier, e.g. the chip serial number, together with the further access entitlement data, e.g. period of validity, such as day ski pass, type of card, e.g. adult, and similar information, including skiing area or ski lift.

The identification data, e.g. chip serial number, and access entitlement data selected by the booking person are passed on and stored in a computer at the access terminal of the winter sports or other facility. When the winter sports enthusiast or customer arrives at the facility and appears at the access terminal, the computer compares the identification data or chip serial number with which the data carrier is coded with the stored identification data or chip serial number.

In case of a match and thus identification of the data carrier of the person who previously performed the booking, the booked access entitlement data, such as period of validity, e.g. day pass, type of card, e.g. adult, and the like are loaded into the data carrier chip.

The reading of the identification data or chip serial number with which the data carrier is coded and the loading of the data carrier chip with the access entitlement data are effected by the data communication device provided at the access terminal, i.e. a read/write device. At first access to the access terminal during the period of validity, the data carrier chip is thus not coded with these access entitlement data, which is detected by the data communication device at the access terminal.

Although the inventive method is primarily intended for booking access entitlements for winter sports facilities, it is also employable for booking access entitlement for other recreational, sports and entertainment facilities such as amusement parks, swimming pools, sports events and other large events and fairs, i.e. in general for all facilities accessible with a valid data carrier via an access terminal.

The data for identification of the data carrier are preferably the serial numbers of the microchips, but one can also use other data, in particular data specific to the chip manufacture.

The data carrier can be e.g. a contact-type smart card. However, one preferably uses as a data carrier a contactless-type data carrier with a preferably passive RFID transponder. Such a data carrier has an antenna. Chip and antenna can be integrated into a card that can be carried in or on a garment, but it can also be integrated into a garment, for example gloves, or into a watch. The data carrier can also be worn in the form of a watch on the wrist. Moreover, the non-contacting data carrier, i.e. chip and antenna, can be part of the mobile phone or its casing or protective cover or another part connected with the mobile phone. The mobile phone can thus at the same time form the data carrier, so that no further object for receiving the data carrier is required. According to the invention the cards, gloves, watches, mobile phone or its casing, protective cover, etc., are then provided visibly with the identification data, e.g. chip serial number or the like, for example by a print e.g. at the edge of the card or e.g. engraving on the back of the watch.

The telecommunication devices used can be mobile or stationary communication terminals, e.g. telephones or a PC with an Internet connection. One thus preferably uses communication devices together with modern infrastructures, such as Internet, mobile phones, personal digital assistants and the like.

Instead of booking with a mobile phone for example with SMS (short message service) one can also book through a mobile phone with WAP (wireless application protocol).

One preferably uses a web server which passes on the data conveyed with the mobile phone (GSM), via Internet or similar telecommunication device to the winter sports or other facility or directly to the access terminal.

From the server one can obtain further information, for example on the different skiing areas, prices, weather, turn-outs and the like, with the telecommunication device before booking. The information can be indicated on the display of a mobile phone.

In case of a facility, e.g. a winter sports area, with a plurality of access terminals the identification and entitlement data can be passed by the server to a data center of the relevant facility, which passes them on to the data communication device of the access terminal.

In order to reduce the communication effort, the data can also be passed on by the server optionally via the data center of the facility only to the data communication device(s) provided at the access terminal(s), e.g. feeder lift(s) of a skiing region, i.e. for the first access.

If a server is used, the inventive booking method is also transparent for the operators of the facility, e.g. the ski lift operators, since the booking information can be fetched from the server. Moreover, a central server that is permanently serviced offers great security.

When booking via Internet, the person desiring to book an access entitlement can also first call up the home page of the particular winter sports area. He can then convey the data carrier identification data and selected access entitlement data to the Internet provider in charge, which passes them on to the server, the data center of the particular skiing area or directly to the access terminals.

Payment of the booked access entitlement can be effected for example via the telephone bill in case of a booking by telephone, or in the usual way by an e-commerce method with a credit card or by collection from a relayed account in case of an Internet booking.

With the inventive method, the winter sports or other facilities are moreover informed in advance about the number of people expected on the particular day, so that they can better prepare for the expected clients in terms of personnel, food, etc. If the data carrier is lost, a reimbursement for the lost access entitlement booked is also possible anytime according to the invention.

In the following the invention will be explained in more detail with reference to the enclosed drawing, whose single FIGURE shows a block diagram of an embodiment of the inventive method for a winter sports facility.

Thus, mobile phone 1 is used to obtain an offer for skiing areas, prices, etc., from web server 2 according to arrow 3.

Then the access entitlement can be booked for the selected winter sports area according to arrow 4, whereby mobile phone 1 conveys to server 2 chip serial number 6 provided visibly on the data carrier, e.g. smart card 5, and the desired access entitlement data, e.g. day pass, adult.

From server 2 said data are passed on to data center 7 of the relevant winter sports area according to arrow 10 and from there to access terminals 8 of the feeder lift (not shown).

Chip serial number 6 and the booked access entitlement data are stored in computer 11 of the data center of the winter sports area, which is connected to access terminals 8. When the customer enters access terminal 8, computer 11 of access terminals 8 compares the chip serial number with which the chip in card 5 of the person entering access terminal 8 is coded with the chip serial numbers stored in computer 11 via data communication device 9 formed as a read/write device.

In case of a match and thus identification of data carrier 5 the booked, stored access entitlement data, such as skiing area or lift, day ski pass, adult, are loaded into the data carrier chip. According to arrow 12 the booking information can be fetched anytime from server 2 by data center 7 of the winter sports area.

1. A method for booking access entitlement for a facility accessible with a codable data carrier (5) via an access terminal (8) provided with a data communication device (9) for reading and for reading and coding data on the data carrier (5), characterized in that one uses a data carrier (5) coded with identification data which are provided visibly (6) on the data carrier (5), the identification data are conveyed together with the access entitlement data to be booked via a telecommunication device to the access terminal (8) and stored there, the data carrier (5) is identified upon arrival at the facility at the access terminal (8) with the data communication device (9) by comparison of the identification data coded thereon with the stored identification data, and the previously booked access entitlement data are coded on the identified data carrier (5) by the data communication device (9).

2. A method according to claim 1, characterized in that one uses a data carrier (5) with a chip, and the identification data of the data carrier (5) are formed by a unique identifier stored in the chip and provided visibly on the data carrier (5).

3. A method according to claim 1 or 2, characterized in that a contactlessly communicating data carrier (5) is used.

4. A method according to any of the above claims, characterized in that at least one server (2) is used which passes on the identification and booking data conveyed with the telecommunication device to the data communication device (9).

5. A method according to claim 1 or 4, characterized in that in case of a facility with a plurality of access terminals (8) the identification and booking data are passed on only to the data communication device (9) of that access terminal (8) of the facility which is intended for the first access to the facility.

6. A method according to claim 1, characterized in that the telecommunication devices used are mobile or stationary communication terminals.

7. A method according to claim 6, characterized in that the telecommunication devices used are the Internet, mobile phones and/or personal digital assistants.

8. A method according to claim 6 or 7, characterized in that the contactlessly communicating data carrier is part of the mobile communication terminal or its casing or a part connected therewith.

9. A method according to any of the above claims, characterized in that the data carrier is integrated into a watch or has the form of a watch.
